(19) United States
(12) Patent Application Publication
(10) Pub. No.: US 2024/0052876 A1
(43) Pub. Date: Feb. 15, 2024

(54) SCREW ASSEMBLY

(71) Applicant: GoodB Co., Ltd., Icheon-si (KR)

(72) Inventor: Jong Young KIM, Icheon-si (KR)

(21) Appl. No.: 18/048,108

(22) Filed: Oct. 20, 2022

(30) Foreign Application Priority Data
Aug. 11, 2022 (KR) 10-2022-0100843

(51) Int. Cl. F16B 43/00

(52) U.S. Cl. CPC F16B 43/001; F16B 5/0241

(57) ABSTRACT

The present invention relates to a screw assembly for fastening an object, including a bolt which is insertable into through-holes of fastening objects that are coincident with each other, and having a threaded portion having a male thread formed on at least a part of an outer circumferential surface, and a bolt head formed at one end of the thread portion inserted into the through-holes together with the thread portion, a nut having a female thread formed on an inner circumferential surface so as to be screw-coupled with the male thread, and a gripping member which is coupled to the thread portion so as to be interposed between the bolt head and the nut, and is elastically deformable to a shape capable of gripping the bolt by a pressure applied from the bolt and the nut when the bolt and the nut are screw-coupled.

### CROSS-REFERENCE TO RELATED APPLICATION

This application claims priority to and the benefit of Korean Patent Application No. 10-2022-0100843, filed on Aug. 11, 2022, the disclosure of which is incorporated herein by reference in its entirety.

### TECHNICAL FIELD

The present invention relates to a screw assembly.

### BACKGROUND ART

The screw assembly refers to a member for fastening objects to be fastened by using bolts and nuts provided to be screw-coupled to each other.

FIG. 1 is a cross-sectional view showing a state in which fastening objects are fastened by a conventional screw assembly.

Referring to FIG. 1, the conventional screw assembly 100 includes a bolt 110 having a male thread formed on the outer circumferential surface of a thread portion, a nut 120 having a female thread formed on the hollow inner circumferential surface which is formed so as to insert a thread portion of the bolt 100, and at least one washer 130, 140 which is respectively interposed in the interface of the bolt head 112 and any one of fastening objects (P1, P2), and at least one interface of interfaces between the nut 120 and the other one of the fastening objects (P1, P2), respectively.

According to this conventional screw assembly 100, in a state where the thread portion of the bolt 110 is inserted into the through-holes (H1, H2) of the fastening objects (P1, P2) facing each other, after the bolt 110 and the nut 120 are temporarily coupled such that the end of the female thread of the nut 120 is seated on the end of the male thread of the bolt 110, as the bolt 110 and the nut 120 are screw-coupled together, the bolt 110 or the nut 120 is rotated in a predetermined tightening direction such that the bolt head 112 and the nut 120 tighten the fastening objects (P1. P2), thereby fastening the fastening objects (P1, P2).

In general, when the female thread of the nut 120 reaches a predetermined snug level of the male thread of the bolt 110 when the bolt 110 and the nut 120 are screw-coupled together, the torque acting on any one of the bolt 110 and the nut 120 also acts on the other one of the bolt 110 and the nut 120 such that the bolt 110 and the nut 120 are mutually constrained, and thus, the bolt 110 and the nut 120 may be rotated together.

Accordingly, in the conventional screw assembly 100, when the bolt 110 and the nut 120 are screw-coupled together, in order to prevent idling in which the bolt 110 and the nut 120 rotate together while being mutually constrained from occurring, any one of the bolt head 122 and the nut 120 must be gripped so as not to rotate, and at the same time, the other one of the bolt head 112 and the nut 120 must be rotated.

However, the installation space of the fastening objects (P1, P2) is divided with the fastening objects (P1, P2) therebetween. Accordingly, as in the case where any one space of the spaces divided by the fastening objects (P1, P2) is located inside a closed device or is very narrow and only the other space is located outside which is wide open, the installation environment of the fastening objects (P1, P2) is often inaccessible to the operator's hand or tool in any one space of the spaces divided by the fastening objects (P1, P2). Accordingly, the conventional screw assembly 100 had a problem in that it can be applied only in limited cases where the operator's hand or tool can be approached in all of the spaces divided by the fastening objects (P1, P2).

### DISCLOSURE

### Technical Problem

The present invention has been devised to solve the problems of prior art described above, and it is an object of the present invention to provide an improved screw assembly that can be applied to a limited installation environment in which the operator's hand or tool can be accessed only in one space of the spaces divided by fastening objects.

### Technical Solution

The screw assembly according to a preferred exemplary embodiment of the present invention for solving the above-described problems relates to a screw assembly for fastening object to be fastened, including a bolt which is provided so as to be insertable into through-holes of fastening objects that are coincident with each other, and having a thread portion having a male thread formed on at least a part of an outer circumferential surface, and a bolt head formed at one end of the thread portion so as to be inserted into the through-holes together with the thread portion; a nut having a female thread formed on an inner circumferential surface so as to be screw-coupled with the male thread at all times; and a gripping member which is coupled to the thread portion so as to be interposed between the bolt head and the nut, and is provided to be elastically deformable to a shape capable of gripping the bolt by a pressure applied from the bolt and the nut when the bolt and the nut are screw-coupled.

Preferably, the gripping member includes a first gripping portion having a first insertion hole into which the thread portion is inserted, and provided to be insertable into the through-holes together with the bolt head in a state where the thread portion is inserted into the first insertion hole; and an eccentric shaft which is inserted into the first insertion hole together with the first gripping portion, and is formed to extend from one end of the first gripping portion to be supported by the bolt head in a state of protruding by a predetermined length toward a central axis of the thread portion compared to the first gripping portion.

Preferably, the eccentric shaft is formed such that one side surface is in close contact with the thread portion, and at the same time, the other side surface is in close contact with the bolt head.

Preferably, the thread portion further includes a planar portion whose outer surface is composed of a flat surface and with which the eccentric shaft is in close contact.

Preferably, the eccentric shaft is configured such that the outer surface has a curved or polygonal shape.

Preferably, the eccentric shaft is configured as a part of the first gripping portion that has passed through the through-holes and is folded in two when the pressure is applied to the gripping member, and is provided to form a gripping blade which is inclined toward the bolt head so as to wrap the circumferential surface of the bolt head at the same time in the first gripping portion.

Preferably, the gripping member further includes a second gripping portion into which the thread portion is inserted and which has a second insertion hole that is coincident with the first insertion hole, and is formed to extend from the other end of the first gripping portion opposite to the one end so as to be interposed between the nut and the fastening objects.

Preferably, the second gripping portion is provided to be caught by the fastening objects when the first gripping portion is inserted into the through-holes.

Preferably, the screw assembly further includes a washer which is interposed between the nut and the second gripping portion.

Preferably, the gripping member further includes a stopper portion into which the thread portion is inserted, and which has a third insertion hole that is coincident with the second insertion hole, and is formed to extend from the second gripping portion so as to protrude toward the nut, and wherein the washer has an insertion hole into which the stopper portion is inserted.

Preferably, the washer has a predetermined thickness such that when the second gripping portion is compressed by a predetermined ratio or more by the pressure, the end of the stopper portion protrudes toward the nut through an opening of the insertion hole and is caught by the nut.

Preferably, the nut is further provided with a locking groove which is formed to be recessed on one surface toward the stopper portion such that the end of the stopper portion is caught.

### Advantageous Effects

The present invention relates to a screw assembly, which includes a gripping member that is elastically deformed in the form of strongly holding the thread portion and bolt head of a bolt such that when fastening objects are fastened by using the screw coupling of a bolt and a nut, it prevents idling in which the bolt and nut that are constrained to each other rotate together from occurring, and thus, it is possible to implement a 1-WAY fastening method applicable to a limited installation environment where the operator's hand or tool can be accessed only in one side space of the spaces divided by the fastening object.

### DESCRIPTION OF DRAWINGS

FIG. 1 is a cross-sectional view showing a state in which fastening objects are fastened by a conventional screw assembly.

FIG. 2 is an exploded perspective view of the screw assembly according to a preferred exemplary embodiment of the present invention.

FIGS. 3 and 4 are cross-sectional views for describing a method of temporarily coupling the screw assembly illustrated in FIG. 2 to fastening objects.

FIGS. 5 to 9 are cross-sectional views for describing a method of fastening objects to be fastened by true coupling of the screw assembly illustrated in FIG. 2 to fastening objects.

FIG. 10 is a partially enlarged view of FIG. 9.

FIGS. 11 and 12 are views for comparing the conventional screw assembly and the screw assembly according to a preferred exemplary embodiment of the present invention.

FIG. 13 is a view showing a change aspect for each installation step of the screw assembly according to a preferred exemplary embodiment of the present invention.

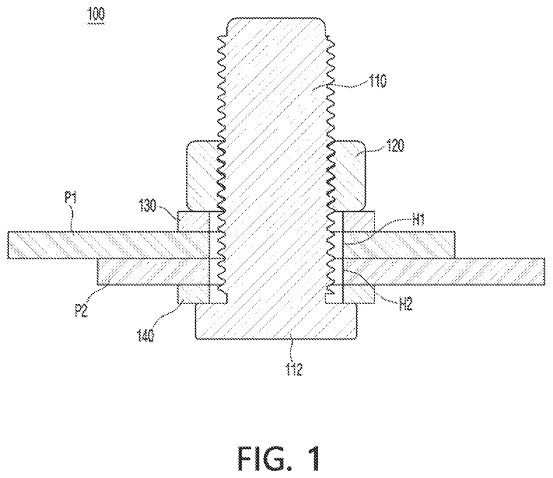

### MODES OF THE INVENTION

Hereinafter, some exemplary embodiments of the present invention will be described in detail with reference to exemplary drawings. In adding reference numerals to the components of each drawing, it should be noted that the same components are given the same reference numerals as much as possible even though they are indicated on different drawings. Further, in describing the exemplary embodiments of the present invention, if it is determined that the detailed description of a related known configuration or function interferes with the understanding of the exemplary embodiments of the present invention, the detailed description thereof will be omitted.

In describing the components of the exemplary embodiments of the present invention, terms such as first, second, A, B, (a), (b) and the like may be used. These terms are only for distinguishing the components from other components, and the essence, order or sequence of the components are not limited by the terms. In addition, unless otherwise defined, all terms used herein, including technical or scientific terms, have the same meaning as commonly understood by one of ordinary skill in the art to which this invention pertains. Terms such as those defined in commonly used dictionaries should be interpreted as having a meaning consistent with the meaning in the context of the related art, and should not be interpreted in an ideal or excessively formal meaning unless explicitly defined in the present application.

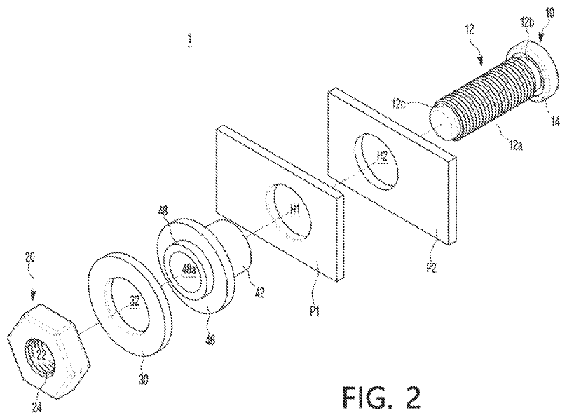

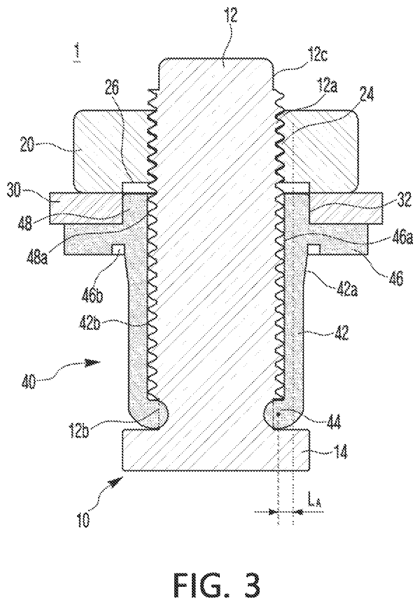

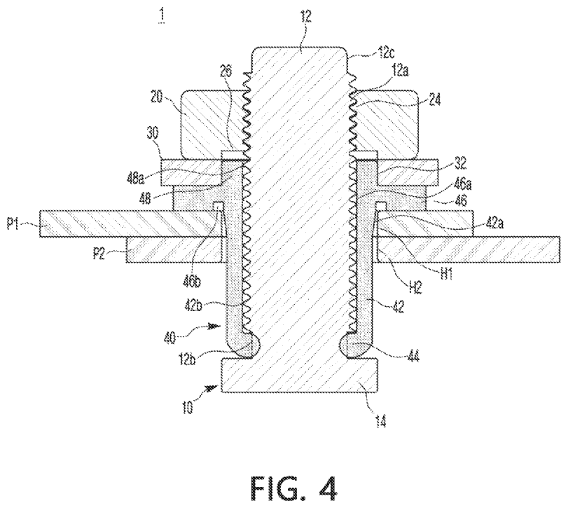

FIG. 2 is an exploded perspective view of the screw assembly according to a preferred exemplary embodiment of the present invention, and FIGS. 3 and 4 are cross-sectional views for explaining a method of temporarily coupling the screw assembly illustrated in FIG. 2 to fastening objects.

Referring to FIG. 2, the screw assembly 1 according to a preferred exemplary embodiment of the present invention is for fastening objects to be fastened (P1, P2) by using a screw coupling, and may include a bolt 10, a nut 20, a washer 30 and a gripping member 40.

The types of fastening objects (P1, P2) that can be fastened by using the screw assembly 1 are not particularly limited. For example, the fastening objects (P1, P2) may have a plate shape having a predetermined thickness. In particular, the screw assembly 1 may be applied to both of the fastening objects (P1, P2) that are configured in a planar shape and the fastening objects (P1, P2) that are configured in a curved shape having a predetermined curvature.

The number of fastening objects (P1, P2) that can be fastened by using the screw assembly 1 is not particularly limited, and the screw assembly 1 is provided to fasten a plurality of fastening objects (P1, P2) stacked in multiple stages along the thickness direction.

As illustrated in FIG. 2, for the convenience of explanation, hereinafter, the present invention will be described by exemplifying the case of fastening a pair of fastening objects (P1, P2) that are configured in a flat shape and stacked along the thickness direction by using the screw assembly 1.

Meanwhile, as illustrated in FIG. 2, in order to fasten the fastening objects (P1, P2) by using the screw assembly 1, through-holes (H1, H2) for installing the screw assembly 1 in each of the fastening objects (P1, P2) must be drilled in advance in the thickness direction of the fastening objects (P1, P2). In addition, the through-holes (H1, H2) have a predetermined diameter such that the first gripping portion 42 of the gripping member 40 to be described below may be inserted. Further details on the coupling relationship between the through-holes (H1, H2) and the screw assembly 1 will be described below.

First, the bolt 10 is a screw member that provides a male thread 12a for screwing the bolt 10 and the nut 20.

As illustrated in FIG. 2, the bolt 10 may include a thread portion 12 for providing a male thread 12a for screw-coupling the corresponding bolt 10 and nut 20, and a bolt head 14 which is configured at the upper end of the thread portion 12 and configured in a flange shape having a diameter larger than the diameter of the thread portion 12 by a predetermined ratio.

The thread portion 12 has a cylindrical shape which is elongated along the longitudinal direction. This thread portion 12 has a male thread 12a which is formed on the outer circumferential surface.

It is preferable that the male thread 12a is not formed on the lower part and the upper part of the thread part 12, but is formed only in the central part located between the lower part and the upper part of the thread part 12. In this case, planar portions 12b, 12c having a flat outer circumferential surface may be formed on each of the upper and lower parts of the thread portion 12. However, the present invention is not limited thereto, and the male thread 12a may be formed to extend to at least one of the upper part and the lower part of the screw part 12. Hereinafter, for the convenience of explanation, the present invention will be described on the basis of the case in which the male thread 12a is formed only in the central part of the thread portion 12 and the planar portions 12b, 12c are formed in the upper and lower parts of the thread portion 12.

The thread portion 12 has a smaller diameter by a predetermined ratio compared to the diameters of the through-holes (H1, H2). For example, as illustrated in FIG. 3, when the male thread 12a is formed to protrude by a predetermined height in the radial direction of the thread portion 12 compared to the planar portion 12b, the male thread 12a may have a diameter smaller than the diameter of the through-holes (H1, H2) by a predetermined ratio.

Next, the nut 20 is a thread member for providing a female thread 24 for screw-coupling the bolt 10 and the nut 20.

As illustrated in FIGS. 2 and 3, the nut 20 may include an insertion hole 22 which is drilled along the thickness direction such that the thread portion 12 of the bolt 10 may be inserted, a female thread 24 which is formed on the inner circumferential surface of the insertion hole 22 so as to be screw-coupled with the male thread 12a of the thread portion 12, and a locking groove 26 which is formed to be recessed in a predetermined depth on the bottom surface such that the stopper portion 48 of the gripping member 40 to be described below may be locked when the bolt 10 and the nut 20 are screw-coupled together.

In addition, the locking groove 26 has a ring shape surrounding the outer periphery of the insertion hole 22, and preferably has an outer diameter larger than the outer diameter of the stopper portion 48 by a predetermined ratio. These locking grooves 26 may be omitted when the stopper portion 48 is not formed in the gripping member 40.

Next, the washer 30 is a member for evenly distributing a pressure applied from the nut 20 when the bolt 10 and the nut 20 are screw-coupled together.

As illustrated in FIG. 2, the washer 30 has an insertion hole 32 which is drilled along the thickness direction such that the thread portion 12 of the bolt 10 and the stopper portion 48 of the gripping member 40 may be inserted.

As illustrated in FIG. 3, the washer 30 preferably has a larger diameter by a predetermined ratio compared to the outer diameter of the nut 20 and the outer diameter of the second gripping portion 46 of the gripping member 40 to be described below, but the present invention is not limited thereto.

The insertion hole 32 preferably has a diameter equal to the outer diameter of the stopper portion 48 or larger by a predetermined ratio compared to the outer diameter of the stopper portion 48. However, the present invention is not limited thereto, and when the stopper portion 48 is not formed in the gripping member 40, the insertion hole 32 may have a diameter that is the same as the diameter of the screw part 12 or is larger than the diameter of the screw part 12 by a predetermined ratio.

The washer 30 is installed such that the thread portion 12 and the stopper portion 48 of the gripping member 40 installed to surround the thread portion 12 are inserted into the insertion holes 32 of the washer 30 such that it may be interposed between the nut 20 and the second gripping portion 46 of the gripping member 40. Through this, the washer 30 may evenly distribute a pressure applied from the nut 20 when the bolt 10 and the nut 20 are screw-coupled together and transmit the same to the second gripper 46, and when the bolt 10 and the nut 20 are screw-coupled, it is possible to prevent the gripping member 40 from being twisted by the rotational force applied from the nut 20.

Next, the gripping member 40 is a member for gripping the bolt such that when the bolt 10 and the nut 20 are screw-coupled to fasten the fastening objects (P1, P2), it is possible to prevent idling in which the bolt 10 and the nut 20 are rotated together while being constrained to each other from occurring.

As illustrated in FIG. 3, the gripping member 40 may include a first gripping portion 42, an eccentric shaft 44, a second gripping portion 46 and a stopper portion 48.

It is preferable that at least a part of the gripping member 40 is configured with an elastic material whose coefficient efficient acting between the corresponding gripping member 40 and the fastening objects (P1, P2), between the gripping member 40 and the bolt, between the gripping member 40 and the nut 20 and between the gripping member and the washer 30 is greater than equal to a predetermined reference value. For example, when the fastening objects (P1, P2), the bolt 10, the nut 20 and the washer 30 are configured with iron or other metal materials, at least a part of the gripping member 40 may be configured with a rubber material that has a relatively high coefficient of friction between iron and other metal materials and is elastically deformable.

As illustrated in FIG. 4, the first gripper 42 has an outer diameter that can be inserted into the through-holes (H1, H2) of the fastening objects (P1, P2), and may be configured in a cylindrical shape having a length as long as a predetermined ratio compared to the summed thickness of the fastening objects (P1, P2).

In addition, the upper end portion 42a of the first gripper 42 may have a diameter equal to the diameter of the through-holes (H1, H2) or larger than the diameter of the through-holes (H1, H2) by a predetermined ratio. Correspondingly, the remaining part of the first gripping portion 42 except for the upper end portion 42a may have a diameter smaller than the diameter of the through-holes (H1, H2) by a predetermined ratio.

To this end, an inclined structure having a diameter gradually increasing toward the second gripping portion 46 may be formed on the upper end portion 42a of the first gripping portion 42. Then, when the first gripping portion 42 is inserted into the through-holes (H1, H2), the remaining parts of the first gripping portion 42 except for the upper end portion 42a may easily pass through the through-holes (H1, H2) without interference from the inner circumferential surfaces of the through-holes (H1, H2, and the upper end 42a of the first gripping portion 42 may be gradually fitted into the through-holes (H1, H2) while being in contact with the inner circumferential surfaces of the through-holes (H1, H2). Accordingly, the upper end portion 42a of the first gripper 42 which is fitted into the through-holes (H1, H2) may seal a space between the inner circumferential surfaces of the through-holes (H1, H2) and the thread portion 12 of the bolt 10, and the gripping member 40 may be fixed to the through-holes (H1, H2) so as not to be separated from the through-holes (H1, H2).

In addition, the first gripping portion 42 may have a first insertion hole 42b formed along the thickness direction of the fastening objects (P1, P2) therein such that the thread portion 12 of the bolt 10 may be inserted therein. In addition, the first insertion hole 42b has a diameter equal to the diameter of the thread portion 12 or larger by a predetermined ratio compared to the diameter of the thread portion 12.

The eccentric shaft 44 protrudes by a predetermined length (LA) toward the central axis of the thread portion 12 compared to the first gripping portion 42, and is formed to extend from the lower end part of the first gripping portion 42, so as to be in close contact with the outer peripheral surface of the planar portion 12b formed in the upper part of the first thread portion 12.

In addition, the eccentric shaft 44 is preferably configured in a ring shape continuously extending along the periphery of the lower end of the first gripping portion 42, but the present invention is not limited thereto.

In addition, the outer surface of the eccentric shaft 44 is preferably configured with a curved surface having a predetermined curvature, but the present invention is not limited thereto. That is, the outer surface of the eccentric shaft 44 may be configured as a polygonal surface.

The second gripping portion 46 is formed to extend from the upper end of the first gripping portion 42. It may be configured in a disk shape having an outer diameter larger by a predetermined ratio compared to the diameter of the through-holes (H1, H2) and the outer diameter of the upper end portion 42a of the first gripping member such that when the first gripping portion 42 is inserted into the through-holes (H1, H2), it may be caught by the fastening objects (P1, P2). However, the present invention is not limited thereto, and the second gripper 46 may be configured in a polygonal plate shape.

The second gripping portion 46 is formed along the thickness direction of the fastening objects (P1, P2) therein such that the thread portion 12 of the bolt 10 may be inserted, and the lower end may have a second insertion hole 46a which is formed to coincide with the upper end of the first insertion hole 42b of the first gripping portion 42, and an guide groove 46b which is formed to be recessed to a predetermined depth on the bottom surface such that the second gripping portion 46 may be guided to be bent in accordance with the curvature of the fastening object (P1, P2). In addition, the guide groove 46b is preferably configured in a ring shape having an inner diameter smaller than the outer diameter of the stopper portion 48 by a predetermined ratio and an outer diameter larger than the outer diameter of the stopper portion 48 by a predetermined ratio, but the present invention is not limited thereto.

The stopper portion 48 is formed to extend from the upper end of the second gripping portion 46 so as to protrude toward the nut 20. The stopper portion 48 may be configured in a ring shape having an outer diameter equal to the diameter of the insertion hole 32 or larger than the diameter of the insertion hole 32 by a predetermined ratio such that it may be inserted into the insertion hole 32 of the washer 30. However, the present invention is not limited thereto, and the stopper portion 48 may have a polygonal plate shape.

In addition, the stopper portion 48 may have a height equal to the thickness of the washer 30 or smaller by a predetermined ratio compared to the thickness of the washer 30 such that the upper end protrudes from the upper opening of the insertion hole 32 toward the bottom surface of the nut 20 only when the second gripping portion 46 is pressed by the washer 30 and the thickness is compressed as thin as a predetermined ratio or more such that it may be caught on the ceiling surface of the locking groove 26.

The stopper portion 48 may have a third insertion hole 48a which is formed along the thickness direction of the fastening objects (P1, P2) therein such that the thread portion 12 of the bolt 10 may be inserted, and the lower end coincides with the upper end of the second insertion hole 46a of the second grilling portion 46.

Hereinafter, the method of temporarily coupling the screw assembly 1 to the fastening objects (P1, P2) will be described with reference to the drawings.

First, as illustrated in FIG. 3, the gripping member 40 is interposed between the bottom surface of the bolt head 14 and the bottom surface of the nut 20, and the screw assembly is assembled by sequentially coupling the bolt 10, the nut 20, the washer 30 and the gripping member 40 such that the washer 30 is interposed between the second gripping portion 46 of the gripping member and the bottom surface of the bolt head 14.

In this case, the bolt 10 and the nut 20 are preferably screw-coupled only to the snug level where the bolt 10 and the nut 20 start to be mutually constrained by a frictional force acting between the male thread 12a and the female thread 24. Then, in a state where the gripping member 40 is not elastically deformed and maintains a circular shape, the inner surface of the eccentric shaft 44 is in close contact with the outer peripheral surface of the planar portion 12b so as to be supported by the outer peripheral surface of the planar portion 12b, and the bottom surface of the eccentric shaft 44 is in close contact with the bottom surface of the bolt 10 so as to be supported by the bottom surface of the bolt 10, and the stopper portion 48 is inserted into the insertion hole 32 of the washer 30, and the washer 30 is interposed between the bottom surface of the nut 20 and the upper surface of the second gripping portion 46.

Next, as illustrated in FIG. 4, the fastening objects (P1, P2) are arranged to overlap each other in multiple stages such that the through-holes (H1, H2) coincide with each other.

Afterwards, the bolt head 14, a part of the thread portion 12 inserted into the lower part of the first insertion hole 42b of the first gripping portion 42, the lower part of the first gripping portion 42 and the eccentric shaft 44 are inserted into the through-holes (H1, H2) so as to penetrate the through-holes (H1, H2) from one side of the fastening objects (P1, P2) toward the other side opposite to the one side, but the bottom surface of the second gripping portion 46 is inserted so as to be caught on the outer surface of the fastening object (P1) located on the side of the second gripping portion 46 among the fastening objects (P1, P2).

Then, all of the bolt head 14 and the eccentric shaft 44 pass through the through-holes (H1, H2) and protrude to the other side of the fastening object (P1, P2), and the thread portion 12 and the first gripping portion 42 protrude to the other side of the fastening objects (P1, P2) by passing through only a part of the through-holes (H1, H2). In addition, the screw assembly 1 is fixed to the through-holes (H1, H2) by the upper end portion 42a of the first gripping portion 42 fitted into the through-holes (H1, H2), so as to be temporarily coupled to the fastening objects (P1, P2).

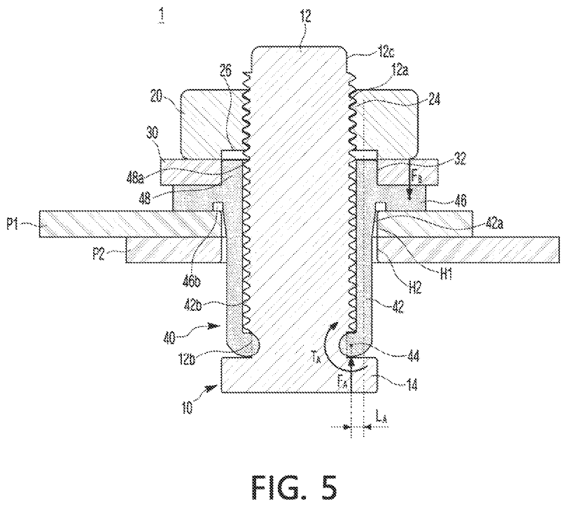

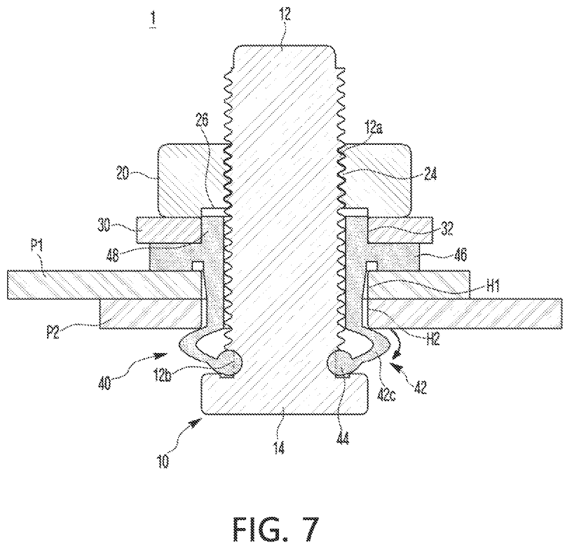

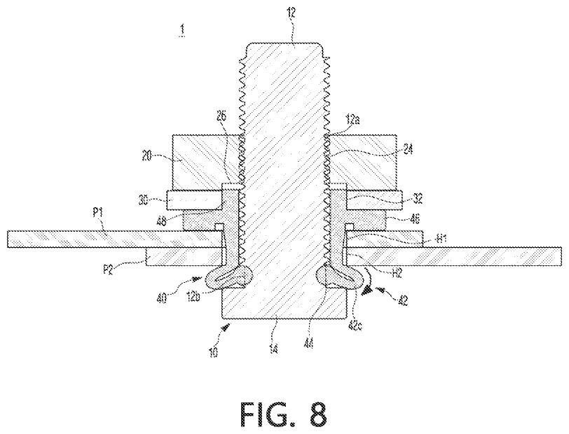

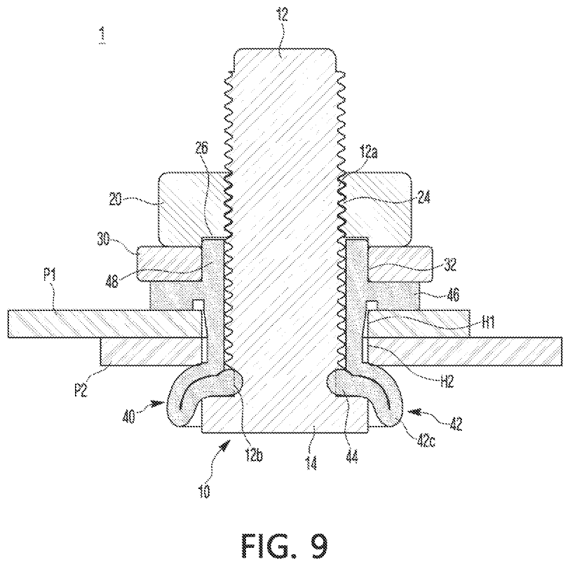

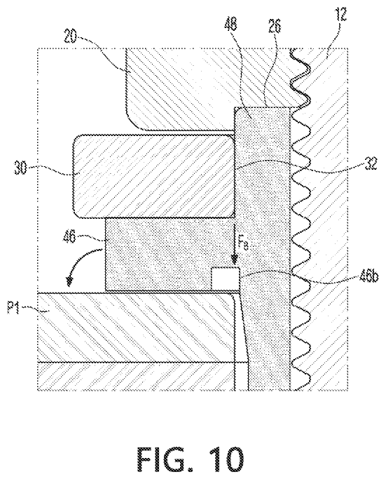

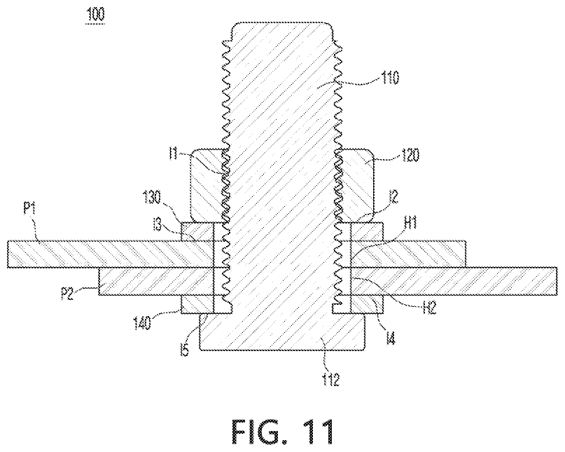

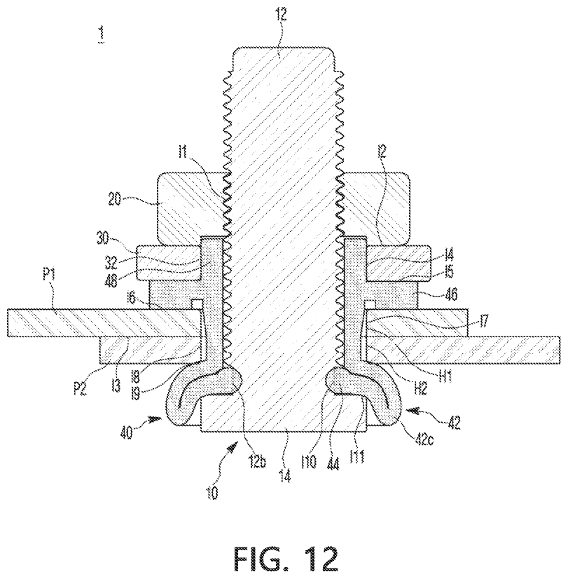

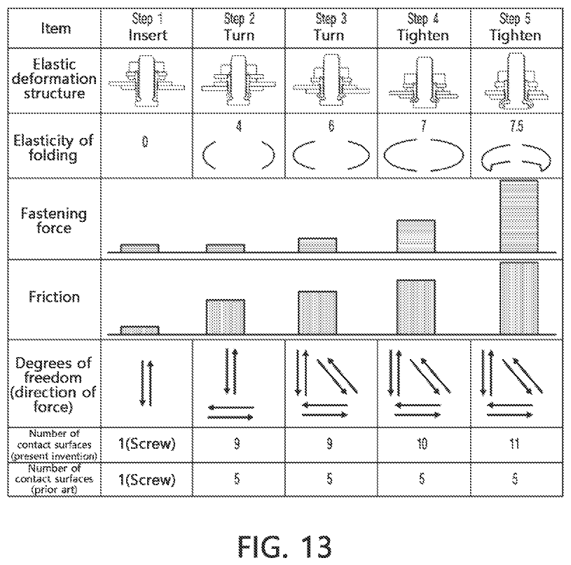

FIGS. 5 to 9 are cross-sectional views for explaining a method of fastening objects to be fastened by true coupling of the screw assembly illustrated in FIG. 2 to fastening objects, FIG. 10 is a partially enlarged view of FIG. 9, FIGS. 11 and 12 are views for comparing the conventional screw assembly and the screw assembly according to a preferred exemplary embodiment of the present invention, and FIG. 13 is a view showing a change aspect for each installation step of the screw assembly according to a preferred exemplary embodiment of the present invention.

Hereinafter, with reference to the drawings, the method for truly coupling the screw assembly 1 which is temporarily coupled to the fastening objects (P1, P2) to the fastening objects (P1, P2) to fasten the fastening objects (P1, P2) will be described.

First, the nut 20 is gripped by using the operator's hand or a tool, and then rotated in a predetermined tightening direction. In this case, it is preferable to leave the bolt head 14 freely in an ungripped state, but the present invention is not limited thereto.

Then, the female thread 24 of the nut 20 pushes the male thread 12a of the bolt 10 toward the nut 20, thereby moving the bolt 10 toward the nut 20. Accordingly, the nut 20 and the bolt 10 apply compressive forces (FA, FB) to the washer 30 and the gripping member 40 interposed between the nut 20 and the bolt 10. By the way, the gripping member 40 includes an eccentric shaft 44 which protrudes by a predetermined length (LA) toward the central axis of the thread portion 12 compared to the first gripping portion 42 such that the inner surface and the bottom surface are respectively in close contact with the outer peripheral surface of the planar portion 12b and the bottom surface of the bolt head 14. Accordingly, as illustrated in FIG. 5, a torque (TA) for inducing the rotation of the eccentric shaft 44 in a direction where the eccentric shaft 44 may be bent toward the inner circumferential surface of the first insertion hole 42b acts on the eccentric shaft 44.

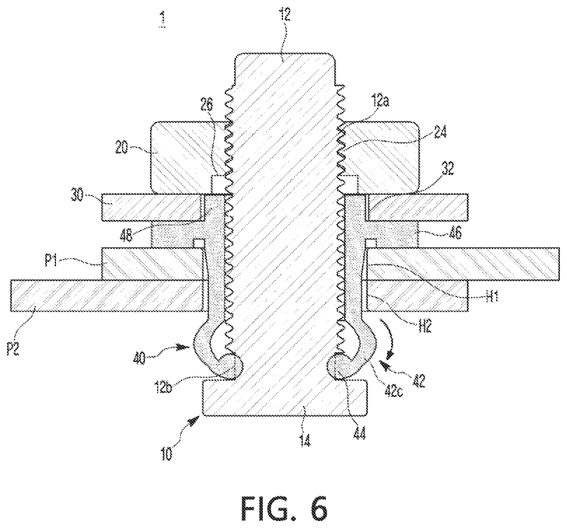

Then, as illustrated in FIGS. 6 to 9, a part of the first gripping portion 42 passing through the through-holes (H1, H2) is compressed by compression forces (FA, FB) which is applied from the bolt 10 and the nut 20, FB), and at the same time, it is elastically deformed so as to be gradually wound in a spiral shape along the eccentric shaft 44 rotated by the torque (TA). As a result, a part of the first gripping portion 42 is formed with a gripping blade 42c having a structure that is bent in a downward direction so as to be folded in two layers and at the same time to wrap the circumferential surface of the bolt head 14. The forming operation of the gripping blade 42c is preferably performed until the upper part of the gripping blade 42c is in close contact with the outer surface of the fastening object (P2) located on the side of the bolt head 14 passing through the through-holes (H1, H2) among the fastening objects (P1, P2), and the lower part is in close contact with the bottom surface and the circumferential surface of the bolt head 14, but the present invention is not limited thereto.

When the aforementioned gripping blade 42c is formed, the eccentric shaft 44 is maintained in close contact with the planar portion 12b of the thread portion 12. Accordingly, the fastening objects (P1, P2) may be mutually fastened by the screw assembly 1 by being tightened up and down by the gripping blade 42c and the second gripping portion 46, in a state where the planar portion 12b of the thread portion 12a and the bottom surface and circumferential surface of the bolt head 14 are strongly gripped by the eccentric shaft 44 and the gripping blade 42.

When the fastening objects (P1, P2) are fastened, the eccentric shaft 44 and the gripping blade 42c strongly hold the bolt 10 such that idling in which the bolt 10 rotates along the nut 20 by a frictional force acting between the male thread 12a of the bolt 10 and the female thread 24 of the nut 20 does not occur. Accordingly, the screw assembly 1 may implement a 1-WAY fastening method in which the operator may fasten the fastening objects (P1, P2) even by rotating the nut 20 without gripping the bolt 10 by a hand or a tool. Through this, the screw assembly 1 may have versatility that is applicable to a limited installation environment in which the operator's hand or tool can be approached only in any one space of the spaces divided by the fastening objects (P1, P2).

In the above, the screw coupling of the bolt 10 and the nut 20 has been described as being performed by rotating the nut 20, but the present invention is not limited thereto. That is, by rotating the bolt head 14 in a state where the nut 20 is freely placed, the screw coupling according to the above-described 1-WAY method may be performed.

In addition, as illustrated in FIG. 9, when the gripping member 40 is strongly pressed by the bolt head 14 and the nut 20 to the extent that the gripping blade 42c is formed, the thickness of the second gripping portion 46 is thinly compressed. Then, the washer 30 is moved toward the fastening objects (P1, P2) by the reduced thickness of the second gripping portion 46, whereby the upper end of the stopper portion 48 may protrude into the locking groove 26 through the upper opening of the insertion hole 32 to be caught on the ceiling surface of the locking groove 26. Then, a strong frictional force acts between the stopper portion 48 and the ceiling surface of the locking groove 26 to stop the rotation of the nut 20 such that the fastening operation of the fastening object (P1, P2) by using the screw assembly 1 may be completed.

In addition, as illustrated in FIG. 10, pressure is applied to the stopper portion 48 when the upper end of the stopper portion 48 is in close contact with the ceiling surface of the locking groove 26. However, since the guide groove 46b has an inner diameter that is smaller than the outer diameter of the stopper portion 48, some of the compressive force applied to the stopper portion 48 is transmitted to the second gripper part 46. Accordingly, when the fastening objects (P1, P2) have a curved surface shape having a predetermined curvature, the second gripping portion 46 is bent to have a curvature corresponding to the curvature of the fastening objects (P1, P2) by the pressure transmitted from the stopper portion 48 under the guidance of the guide groove 46b, so as to be in close contact with the fastening objects (P1, P2).

Meanwhile, as illustrated in FIG. 11, when a pair of fastening objects (P1, P2) are fastened by using the conventional screw assembly 100, frictional force acts on five interfaces, including a first contact surface to a fifth contact surface (I1 to I5).

However, as illustrated in FIGS. 12 and 13, when a pair of fastening objects (P1, P2) are fastened by using the screw assembly 1 into which the gripping member 40 is introduced, frictional force acts on 11 interfaces such as a first contact surface to an eleventh contact surface (I1 to I11). Accordingly, the screw assembly 1 may increase the number of friction interfaces and the friction area compared to the conventional screw assembly 100. Through this, when the fastening operation of the fastening objects (P1, P2) is performed, the screw assembly 1 increases the frictional force acting between the fastening objects (P1, P2) and the various members provided in the screw assembly 1 by using the gripping member 40 to increase the frictional force between the fastening objects P1 and P2 such that the fastening force of the fastening objects (P1, P2) may be improved. In addition, since the vibration, rotational force and other external force applied to the fastening objects (P1, P2) are absorbed by the gripping member 40 configured with an elastic material and are buffered, the screw assembly 1 may prevent loosening of the screw coupling between the bolt 10 and the nut 20 through this.

The above description is merely illustrative of the technical spirit of the present invention, and various modifications and variations will be possible without departing from the essential characteristics of the present invention by those skilled in the art to which the present invention pertains.

Therefore, the exemplary embodiments disclosed in the present invention are for explanation rather than limiting the technical spirit of the present invention, and the scope of the technical spirit of the present invention is not limited by these exemplary embodiments. The protection scope of the present invention should be interpreted by the following claims, and all technical ideas within the scope equivalent thereto should be construed as being included in the scope of the present invention.

### EXPLANATION OF REFERENCE NUMERALS

| | |
|---|---|
| 1: Screw assembly | |
| 10: Bolt | |
| 12: Thread portion | 12a: Male thread |
| 12b, 12c: Planar portion | 14: Bolt head |
| 20: Nut | |
| 22: Insertion hole | 24: Female thread |
| 26: Locking groove | |
| 30: Washer | |
| 32: Insertion hole | |
| 40: Gripping member | |
| 42: First gripping portion | 42a: Upper end portion |
| 42b: First insertion hole | 42c: Gripping blade |
| 44: Eccentric shaft | 46: Second gripping portion |
| 46a: Second insertion hole | 46b: Guide groove |
| 48: Stopper portion | 48a: Third insertion hole |
| 100: Conventional screw assembly | |
| 110: Bolt | 112: Bolt head |
| 120: Nut | |
| 130, 140: Washer | |
| P1, P2: Fastening object | |
| H1, H2: Through-hole | |

1. A screw assembly for fastening object to be fastened, comprising:
a bolt which is provided so as to be insertable into through-holes of fastening objects that are coincident with each other, and having a thread portion having a male thread formed on at least a part of an outer circumferential surface, and a bolt head formed at one end of the thread portion so as to be inserted into the through-holes together with the thread portion;
a nut having a female thread formed on an inner circumferential surface so as to be screw-coupled with the male thread at all times; and
a gripping member which is coupled to the thread portion so as to be interposed between the bolt head and the nut, and is provided to be elastically deformable to a shape capable of gripping the bolt by a pressure applied from the bolt and the nut when the bolt and the nut are screw-coupled.

2. The screw assembly of claim 1, wherein the gripping member comprises:
a first gripping portion having a first insertion hole into which the thread portion is inserted, and provided to be insertable into the through-holes together with the bolt head in a state where the thread portion is inserted into the first insertion hole; and
an eccentric shaft which is inserted into the first insertion hole together with the first gripping portion, and is formed to extend from one end of the first gripping portion to be supported by the bolt head in a state of protruding by a predetermined length toward a central axis of the thread portion compared to the first gripping portion.

3. The screw assembly of claim 2, wherein the eccentric shaft is formed such that one side surface is in close contact with the thread portion, and at the same time, the other side surface is in close contact with the bolt head.

4. The screw assembly of claim 3, wherein the thread portion further comprises a planar portion whose outer surface is composed of a flat surface and with which the eccentric shaft is in close contact.

5. The screw assembly of claim 3, wherein the eccentric shaft is configured such that the outer surface has a curved or polygonal shape.

6. The screw assembly of claim 2, wherein the eccentric shaft is configured as a part of the first gripping portion that has passed through the through-holes and is folded in two when the pressure is applied to the gripping member, and is provided to form a gripping blade which is inclined toward the bolt head so as to wrap the circumferential surface of the bolt head at the same time in the first gripping portion.

7. The screw assembly of claim 6, wherein the gripping member further comprises:
a second gripping portion into which the thread portion is inserted and which has a second insertion hole that is coincident with the first insertion hole, and is formed to extend from the other end of the first gripping portion opposite to the one end so as to be interposed between the nut and the fastening objects.

8. The screw assembly of claim 7, wherein the second gripping portion is provided to be caught by the fastening objects when the first gripping portion is inserted into the through-holes.

9. The screw assembly of claim 7, further comprising:
a washer which is interposed between the nut and the second gripping portion.

10. The screw assembly of claim 9, wherein the gripping member further comprises:
a stopper portion into which the thread portion is inserted, and which has a third insertion hole that is coincident with the second insertion hole, and is formed to extend from the second gripping portion so as to protrude toward the nut, and
wherein the washer has an insertion hole into which the stopper portion is inserted.

11. The screw assembly of claim 10, wherein the washer has a predetermined thickness such that when the second gripping portion is compressed by a predetermined ratio or more by the pressure, the end of the stopper portion protrudes toward the nut through an opening of the insertion hole and is caught by the nut.

12. The screw assembly of claim 11, wherein the nut is further provided with a locking groove which is formed to be recessed on one surface toward the stopper portion such that the end of the stopper portion is caught.
